(19) United States
(12) Patent Application Publication
(10) Pub. No.: US 2018/0214983 A1
(43) Pub. Date: Aug. 2, 2018

(54) METHOD FOR LASER WELDING ALUMINUM WORKPIECES

(71) Applicant: GM GLOBAL TECHNOLOGY OPERATIONS LLC, DETROIT, MI (US)

(72) Inventors: David S. Yang, Shanghai (CN); Wu Tao, Shanghai (CN)

(21) Appl. No.: 15/747,287

(22) PCT Filed: Aug. 31, 2015
(86) PCT No.: PCT/CN2015/088569

§ 371 Date: Jan. 24, 2018

(51) Int. Cl. B23K 26/244; B23K 26/082; B23K 26/322

(52) U.S. Cl. CPC B23K 26/244; B23K 2201/006; B23K 26/322; B23K 26/082

(57) ABSTRACT

A method of laser welding a workpiece stack-up (10) that includes at least two overlapping aluminum workpieces (12, 14), at least one of which includes a protective anti-corrosion coating (38), is disclosed. The disclosed method includes advancing the laser beam (56) relative to the top surface (26) of the workpiece stack-up (10) along a travel path (78, 78′, 78″, 78′″) that imposes bidirectional movement of the laser beam (56). In particular, the laser beam (56) moves in a forward direction (80) while also moving back and forth in a lateral direction (82) oriented transverse to the forward direction (80) as it is being advanced relative to the top surface (26). Such bidirectional movement is believed to help disturb the protective anti-corrosion coating (38) in and around the molten aluminum weld pool (74), thus leading to a laser weld joint (68) that contains less weld defects derivable from the protective anti-corrosion coating(s) (38).

### TECHNICAL FIELD

The technical field of this disclosure relates generally to laser welding and, more particularly, to a method of laser welding together two or more overlapping aluminum workpieces.

### BACKGROUND

Laser welding is a metal joining process in which a laser beam is directed at a metal workpiece stack-up to provide a concentrated energy source capable of effectuating a weld joint between the overlapping constituent metal workpieces. In general, two or more metal workpieces are first aligned and stacked relative to one another such that their faying surfaces overlap and confront to establish a faying interface (or faying interfaces) within an intended weld site. A laser beam is then directed at a top surface of the workpiece stack-up. The heat generated from the absorption of energy from the laser beam initiates melting of the metal workpieces and establishes a molten weld pool within the workpiece stack-up. The molten weld pool penetrates through the metal workpiece impinged upon by the laser beam and into the underlying metal workpiece or workpieces to a depth that intersects each of the established faying interfaces. And, if the power density of the laser beam is high enough, a keyhole is produced directly underneath the laser beam and is surrounded by the molten weld pool. A keyhole is a column of vaporized metal derived from the metal workpieces within the workpiece stack-up that may include plasma.

The laser beam creates the molten weld pool in very short order—typically miliseconds—once it impinges the top surface of the workpiece stack-up. After the molten weld pool is formed and stable, the laser beam is advanced along the top surface of the workpiece stack-up while tracking a predetermined weld path, which has conventionally involved moving the laser beam in a strict forward direction without any side-to-side variation. Such advancement of the laser beam translates the molten weld pool along a corresponding course relative to top surface of the workpiece stack-up and leaves behind molten workpiece material in the wake of the advancing weld pool. This penetrating molten workpiece material cools and solidifies to form a weld joint comprised of re-solidified workpiece material. The resultant weld joint fusion welds the overlapping workpieces together.

The automotive industry is interested in using laser welding to manufacture parts that can be installed on a vehicle. In one example, a vehicle door body may be fabricated from an inner door panel and an outer door panel that are joined together by a plurality of laser welds. The inner and outer door panels are first stacked relative to each other and secured in place by clamps. A laser beam is then sequentially directed at multiple weld sites around the stacked panels in accordance with a programmed sequence to form the plurality of laser weld joints. At each weld site where laser welding is performed, the laser beam is directed at the stacked panels and conveyed along a predefined laser beam travel path, which may be configured to produce the weld joint in any suitable overall shape including, for example, as a circular spot weld joint, a stitch weld joint, or a staple weld joint. The process of laser welding inner and outer door panels (as well as other vehicle part components such as those used to fabricate hoods, deck lids, load-bearing structural members, etc.) is typically an automated process that can be carried out quickly and efficiently.

Aluminum workpieces are an intriguing candidate for many automobile component parts and structures due to their high strength-to-weight ratio and their ability to improve the fuel economy of the vehicle. The use of laser welding to join together aluminum workpieces, however, can present challenges. Most notably, aluminum workpieces almost always include a protective coating that covers an underlying bulk aluminum substrate. This protective coating may be a refractory oxide coating that forms passively when fresh aluminum is exposed to atmospheric air or some other oxygen-containing medium. In other instances, however, the protective coating may be a metallic coating comprised of zinc or tin, or it may be a metal oxide conversion coating comprised of oxides of titanium, zirconium, chromium, or silicon, as disclosed in U.S. Patent Application No. US2014/0360986, the entire contents of which are incorporated herein by reference. The protective coating inhibits corrosion of the underlying aluminum substrate through any of a variety of mechanisms depending on the composition of the coating. But the presence of the protective anti-corrosion coating also makes it more challenging to autogenously fusion weld aluminum workpieces together by way of laser welding.

The protective anti-corrosion coating is believed to affect the laser welding process by introducing weld defects in the final laser weld joint. When, for example, the protective coating is a passive refractory oxide coating, the coating is difficult to break apart and disperse due to its high melting point and mechanical toughness. As a result, residual oxides may accumulate in the molten aluminum weld pool and contribute to the formation of weld defects, such as porosity, in the solidified weld joint. As another example, if the protective coating is zinc, the coating may readily vaporize to produce high-pressure zinc vapors (zinc has a boiling point of about 906° C.) at the faying interface of the aluminum workpieces. These zinc vapors may, in turn, diffuse into and through the molten aluminum weld pool created by the laser beam unless provisions are made to vent the zinc vapors away from the weld site, which may involve subjecting the workpiece stack-up to additional and inconvenient manufacturing steps prior to welding. The other materials mentioned above that may constitute the protective anti-corrosion coating can present similar issues that may ultimately affect and degrade the mechanical properties of the weld joint.

The unique challenges that underlie the use of laser welding to fusion join aluminum workpieces together have lead many manufactures to reject laser welding as a suitable metal joining process despite its potential to bestow a wide range of benefits. In lieu of laser welding, these manufacturers have turned to mechanical fasteners, such self piercing rivets or flow-drill screws, to join together two or more aluminum workpieces. Such mechanical fasteners, however, take much longer to put in place and have high consumable costs compared to laser weld joints. They also increase manufacturing complexity and add extra weight to the part being manufactured—weight that is avoided when joining is accomplished by way of autogenous fusion laser welds—that offsets some of the weight savings attained through the use of aluminum workpieces in the first place. A comprehensive laser welding strategy that can make aluminum laser welding a viable option in even the most demanding manufacturing settings would thus be a welcome addition to the art.

### SUMMARY OF THE DISCLOSURE

A method of laser welding a workpiece stack-up that includes overlapping aluminum workpieces is disclosed. The workpiece stack-up includes two or more aluminum workpieces, and at least one of those aluminum workpieces (and preferably all of the aluminum workpieces) includes a protective anti-corrosion coating. The term “aluminum workpiece” as used here in the present disclosure refers broadly to a workpiece that includes a base aluminum substrate comprised of at least 85 wt. % aluminum. The aluminum workpiece may thus include a base aluminum substrate comprised of elemental aluminum or any of a wide variety of aluminum alloys. Moreover, the protective anti-corrosion coating that covers the base aluminum substrate is preferably the passive refractory oxide coating that naturally forms when fresh aluminum is exposed to atmospheric air or some other source of oxygen. In alternative embodiments, however, the anti-corrosion coating may be a zinc coating, a tin coating, or a metal oxide conversion coating. The disclosed method minimizes the impact that these and other anti-corrosion coatings may have on the properties of final weld joint.

To begin, the laser welding method involves providing a workpiece stack-up that includes two or more overlapping aluminum workpieces (e.g, two or three overlapping aluminum workpieces). The aluminum workpieces are superimposed on each other such that a faying interface is formed between the faying surfaces of each pair of adjacent overlapping aluminum workpieces. For example, in one embodiment, the workpiece stack-up includes first and second aluminum workpieces having first and second faying surfaces, respectively, that overlap and confront one another to establish a single faying interface. In another embodiment, the workpiece stack-up includes an additional third aluminum workpiece situated between the first and second aluminum workpieces. In this way, the first and second aluminum workpieces have first and second faying surfaces, respectively, that overlap and confront opposed faying surfaces of the third aluminum workpiece to establish two faying interfaces. When a third aluminum workpiece is present, the first and second aluminum workpieces may be separate and distinct parts or, alternatively, they may be different portions of the same part, such as when an edge of one part is folded back over on itself and hemmed over a free edge of another part.

After the workpiece stack-up is provided, a laser beam is directed at, and impinges, a top surface of the workpiece stack-up to create a molten aluminum weld pool that penetrates into the workpiece stack-up and intersects each faying interface established within the workpiece stack-up. The power density of the laser beam is selected to carry out the laser welding method in either conduction welding mode or keyhole welding mode. In conduction welding mode, the power density of the laser beam is relatively low, and the energy of the laser beam is conducted as heat through the aluminum workpieces to create only the molten aluminum weld pool. Indeed, the molten aluminum weld pool created during conduction welding mode is relatively shallow, typically having a width at the top surface of the workpiece stack-up that is greater than a penetration depth of the molten aluminum weld pool into the workpiece stack-up. In keyhole welding mode, the power density of the laser beam is high enough to vaporize the aluminum workpieces and produce a keyhole directly underneath the laser beam within the molten aluminum weld pool. The keyhole provides a conduit for energy absorption deeper into workpiece stack-up which, in turn, facilitates deeper and narrower penetration of the molten aluminum weld pool. As such, the molten aluminum weld pool created during keyhole welding mode typically has a width at the top surface of the workpiece stack-up that is less than the penetration depth of the weld pool.

The laser beam is advanced relative to the top surface of the workpiece stack-up along one or more predefined travel paths following creation of the molten aluminum weld pool. In particular, within each laser beam travel path, the laser beam is advanced from a start point to an end point, which may be the same or different points on the top surface, to thereby translate the molten aluminum weld pool along a course that corresponds to the travel path of the laser beam. Such advancement of the laser beam leaves behind molten aluminum workpiece material in the wake of the travel path of the laser beam and the corresponding course of the weld pool. This molten workpiece material quickly cools and solidifies into a weld joint comprised of re-solidified aluminum that autogenously fusion welds the aluminum workpieces together. Here, in the disclosed laser welding method, the weld joint is strong and durable, and its structure and properties are consistently attainable in a manufacturing setting as a result of the peculiar travel path of the laser beam between the start and end points, as will be further explained below. Eventually, upon reaching the end point, the laser beam is removed from the top surface of the workpiece stack-up.

Unlike conventional laser welding practices, in which the laser beam is advanced unidirectionaly in a strict forward direction, the laser beam in the disclosed method experiences movement in two directions as it is advanced relative to the top surface of the workpiece stack-up. Specifically, while being advanced along any of the one or more laser beam travel paths, the laser beam moves in a forward direction away from the start point and towards the end point and further moves back and forth in a lateral direction transverse to the forward direction. The back and forth movement of the laser beam that occurs while the laser beam is also moving in the forward direction is believed to more effectively disturb (e.g., fracture and break down, vaporize, or otherwise) the protective anti-corrosion coating as compared to purely unidirectional movement in the forward direction. The back and forth movement of the laser beam is also believed to clear a wider swath of the protective anti-corrosion coating in an around the course of travel of the molten aluminum weld pool. These two effects attained through the bidirectional movement of the laser beam ultimately minimize the occurrence of source porosity and other related weld defects in the resultant weld joint.

The laser beam can be advanced along myriad travel paths that incorporate both movement in the forward direction and movement back and forth in the lateral direction. For example, in a preferred embodiment, the laser beam is oscillated from the start point to the end point in a sinusoidal pattern that includes repeating waves. These repeating waves have peak-to-peak amplitudes and wavelengths that gauge the movement of the laser beam in the lateral direction and the frequency of such movement, respectively. And, while those characteristics of the travel path of the laser beam may vary depending on several factors, a preferred implementation involving the sinusoidal pattern includes repetitive waves having peak-to-peak amplitudes ranging from 0.1 mm to 6.0 mm and wavelengths ranging from 0.1 mm to 6.0 mm. Of course, other laser beam travel paths may be implemented besides those that embody the sinusoidal pattern. Some examples of alternative travel paths include those that embody a rectangular wave pattern, a zig-zag wave pattern, and a continuous loop pattern, to name but a few.

### BRIEF DESCRIPTION OF THE DRAWINGS

FIG. 1 is a perspective view of an embodiment of a laser welding apparatus for producing a laser weld joint within a workpiece stack-up that includes two or more overlapping aluminum workpieces;

FIG. 2 is a plan view of the top surface of the workpiece stack-up during laser welding in which a laser beam is being advanced relative to the top surface of the workpiece stack-up, wherein the laser beam has created a molten aluminum weld pool that penetrates into the stack-up and has additionally produced a keyhole within the molten aluminum weld pool;

FIG. 3 is a cross-sectional side view of the workpiece stack-up shown in FIG. 2;

FIG. 4 is a cross-sectional view of the workpiece stack-up taken from the same perspective as shown in FIG. 3, although here the workpiece stack-up includes three aluminum workpieces that establish two faying interfaces, as opposed to two aluminum workpieces that establish a single faying interface as depicted in FIG. 3;

FIG. 5 is a plan view of the top surface of a workpiece stack-up during laser welding in which the laser beam is being advanced relative to the top surface along a travel path from a start point to an end point according to one implementation of the disclosed method to form a weld joint comprised of re-solidified aluminum, wherein the advancement of the laser beam comprises movement of the laser beam in a forward direction as well as movement of the laser beam back and forth in a lateral direction transverse to the forward direction;

FIG. 6 is a plan view of the top surface of a workpiece stack-up during laser welding in which the laser beam is being advanced relative to the top surface along a travel path from a start point to an end point according to another implementation of the disclosed method, wherein the advancement of the laser beam comprises movement of the laser beam in a forward direction as well as movement of the laser beam back and forth in a lateral direction transverse to the forward direction;

FIG. 7 is a plan view of the top surface of a workpiece stack-up during laser welding in which the laser beam is being advanced relative to the top surface along a travel path from a start point to an end point according to still another implementation of the disclosed method, wherein the advancement of the laser beam comprises movement of the laser beam in a forward direction as well as movement of the laser beam back and forth in a lateral direction transverse to the forward direction;

FIG. 8 is a plan view of the top surface of a workpiece stack-up during laser welding in which the laser beam is being advanced relative to the top surface along a travel path from a start point to an end point according to yet another implementation of the disclosed method, wherein the advancement of the laser beam comprises movement of the laser beam in a forward direction as well as movement of the laser beam back and forth in a lateral direction transverse to the forward direction;

FIG. 9 is a plan view of the top surface of a workpiece stack-up showing a travel path the laser beam could follow from a start point to an end point in order to form a circle weld joint according to one embodiment of the disclosed method;

FIG. 10 is a plan view of the top surface of a workpiece stack-up showing a travel path the laser beam could follow from a start point to an end point in order to form a staple weld joint according to one embodiment of the disclosed method;

FIG. 11 is a plan view of the top surface of a workpiece stack-up showing a travel path the laser beam could follow from a start point to an end point in order to form a stitch weld joint according to one embodiment of the disclosed method;

FIG. 12 is a plan view of the top surface of a workpiece stack-up showing multiple travel paths to be followed by a laser beam in order to form multiple weld joints according to one embodiment of the disclosed method;

FIG. 13 is a plan view of the top surface of a workpiece stack-up showing multiple travel paths to be followed by a laser beam in order to form multiple weld joints according to yet another embodiment of the disclosed method; and

FIG. 14 is a plan view of the top surface of a workpiece stack-up showing multiple travel paths to be followed by a laser beam in order to form multiple weld joints according to still another embodiment of the disclosed method.

### DETAILED DESCRIPTION

The disclosed method of laser welding a workpiece stack-up comprised of two or more overlapping aluminum workpieces calls for advancing a laser beam relative to a top surface of the workpiece stack-up such that the laser beam experiences movement in forward direction as well as back and forth movement in a lateral direction. Any type of laser welding apparatus, including remote and conventional laser welding apparatuses, may be employed to advance the laser beam relative to the top surface of the workpiece stack-up. Moreover, the operational power density of the laser beam may be selected to perform the method in either conduction welding mode or keyhole welding mode. The laser beam may thus be a solid-state laser beam or a gas laser beam depending on the characteristics of the aluminum workpieces being joined and the laser welding mode desired to be practiced. Some notable solid-state lasers that may be used are a fiber laser, a disk laser, and a Nd:YAG laser, and a notable gas laser that may be used is a CO₂ laser, although other types of lasers may certainly be used so long as they are able to create the molten aluminum weld pool. In a preferred implementation of the disclosed method, which is described below in more detail, a remote laser welding apparatus directs and advances a solid-state laser beam at and along the workpiece stack-up while practicing laser welding in keyhole welding mode.

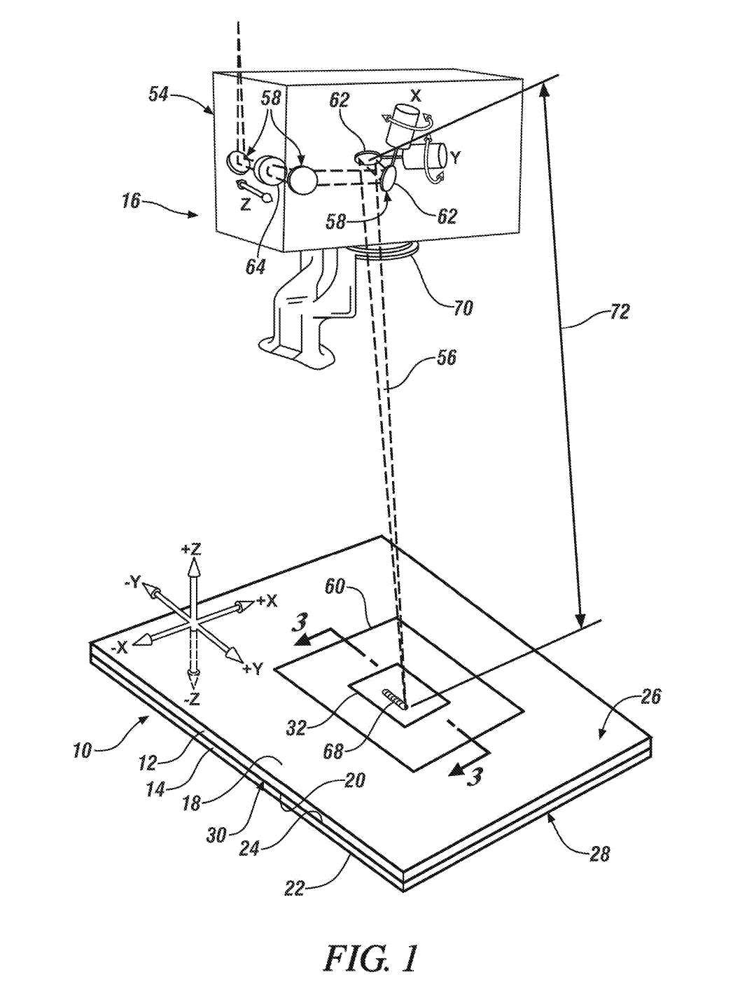

Referring now to FIGS. 1-3, a method of laser welding a workpiece stack-up 10 that includes a first aluminum workpiece 12 and a second aluminum workpiece 14 using a remote laser welding apparatus 16 is shown. The first aluminum workpiece 12 includes an outer surface 18 and a first faying surface 20, and the second aluminum workpiece 14 includes an outer surface 22 and a second faying surface 24. Relative to the position of the remote laser welding apparatus 16, the outer surface 18 of the first aluminum workpiece 12 provides a top surface 26 of the workpiece stack-up 10 and the outer surface 22 of the second aluminum workpiece 14 provides an oppositely-facing bottom surface 28 of workpiece stack-up 10. Conversely, since they are the only two aluminum workpieces depicted in the workpiece stack-up 10, the first and second faying surfaces 20, 24 of the first and second aluminum workpieces 12, 14 overlap and confront one another to establish a faying interface 30 at least within a predetermined weld site 32.

While the faying interface 30 is, broadly speaking, established between the portions of the first and second faying surfaces 20, 24 that overlap and confront one another, the particular attributes of the faying interface 30 can take on several different forms. For instance, the overlapping and confronting portions of the faying surfaces 20, 24 may directly or indirectly contact one another. The faying surfaces 20, 24 are in indirect contact when they are separated by an intermediate material—such as a thin layer of weld-through adhesive or sealer—yet remain in close enough proximity that remote laser welding can still be practiced. Additionally, the overlapping and confronting portions of the faying surfaces 20, 24 can make complimentary flush contact (direct or indirect) at the weld site 32, meaning that the faying surfaces 20, 24 are closely mated together and are not purposefully separated by gaps or spaces imposed by intentionally formed protruding features. This type of close complimentary contact, which allows for small indiscriminate breaks or spaces as a result of acceptable tolerances in the size and shape of the workpieces 12, 14 or otherwise, is permitted since the disclosed method provides another mechanism (i.e., bidirectional laser beam movement) to help counteract the possible adverse effects associated with the boiling of zinc at the faying interface(s). And, while not necessarily required, one or both of the faying surfaces 20, 24 may include protruding features formed by laser scoring, mechanical dimpling, or otherwise, to assist in zinc vapor escape, if desired.

As shown best in FIG. 3, the first aluminum workpiece 12 includes a first base aluminum substrate 34 and the second aluminum workpiece 14 includes a second base aluminum substrate 36. The base aluminum substrates 34, 36 may be composed of elemental aluminum or an aluminum alloy that includes at least 85 wt. % aluminum. Some notable aluminum alloys that may constitute the first and/or second base aluminum substrates 34, 36 are an aluminum-magnesium alloy, an aluminum-silicon alloy, an aluminum-magnesium-silicon alloy, or an aluminum-zinc alloy. The first and/or second base aluminum substrate 34, 36 may, for example, be composed of a 4xxx, 5xxx, 6xxx, or 7xxx series wrought aluminum alloy sheet layer, or a 4xx.x, 5xx.x, or 7xx.x series aluminum alloy casting, and may further be employed in a variety of tempers including annealed (O), strain hardened (H), and solution heat treated (T). Some more specific kinds of aluminum alloys that can be used as the first and/or second base aluminum substrate 34, 36 include, but are not limited to, 5754 aluminum-magnesium alloy, 6022 aluminum-magnesium-silicon alloy, 7003 aluminum-zinc alloy, and Al-10Si-Mg aluminum die casting alloy.

At least one of the first or second aluminum workpieces 12, 14—and preferably both—includes a protective anti-corrosion coating 38 that overlies the base aluminum substrate 34, 36. Indeed, as shown in FIG. 3, each of the first and second aluminum substrates 34, 36 is coated with a protective anti-corrosion coating 38 that, in turn, provides the workpieces 12, 14 with their respective outer surfaces 18, 22 and their respective faying surfaces 20, 24. The protective anti-corrosion coating 38 may be a refractory oxide coating that forms passively when fresh aluminum from the base aluminum substrate 34, 36 is exposed to atmospheric air or some other oxygen-containing medium. The protective anti-corrosion coating 38 may also be a metallic coating comprised of zinc or tin, or it may be a metal oxide conversion coating comprised of oxides of titanium, zirconium, chromium, or silicon. A typical thickness of the protective anti-corrosion coating 38, if present, is anywhere from 1 nm to 10 μm thick depending on its composition. Taking into account the thickness of the base aluminum substrates 34, 36 and the optional protective anti-corrosion coatings 38, the first and second aluminum workpieces 12, 14 may have thicknesses in the range of 0.3 mm to 6.0 mm, and more specifically in the range of 0.5 mm to 3.0 mm, at least at the weld site 32. The thicknesses of the first and second aluminum workpieces 12, 14 may be the same as or different from each other.

FIGS. 1-3 illustrate an embodiment of the remote laser welding method in which the workpiece stack-up 10 includes two overlapping aluminum workpieces 12, 14 that have the single faying interface 30. Of course, as shown in FIG. 4, the workpiece stack-up 10 may include an additional third aluminum workpiece 40 situated between the first and second aluminum workpieces 12, 14. The third aluminum workpiece 40, if present, includes a third base aluminum substrate 42 that may be bare or coated with a protective anti-corrosion coating 44 (as shown). The third aluminum workpiece 40 is similar in many general respects to the first and second aluminum workpieces 12, 14 and, accordingly, the description of the first and second aluminum workpieces 12, 14 set forth above (in particular the composition of the base aluminum substrates and the thickness of the workpieces) applies fully to the third aluminum workpiece 40. The third aluminum workpiece 40 may also be employed in any of the tempers noted above with respect to the first and second aluminum workpieces 12, 14, as previously discussed.

As a result of stacking the first, second, and third aluminum workpieces 12, 14, 40 in overlapping fashion to provide the workpiece stack-up 10, the third aluminum workpiece 40 has two faying surfaces 46, 48. One of the faying surfaces 46 overlaps and confronts the faying surface 20 of the first aluminum workpiece 12 and the other faying surface 48 overlaps and confronts the faying surface 24 of the second aluminum workpiece 14, thus establishing two faying interfaces 50, 52 within the workpiece stack-up 10 at the weld site 32. These faying interfaces 50, 52 are the same type and encompass the same attributes as the faying interface 30 already described with respect to FIGS. 1 and 3. Consequently, in this embodiment as described herein, the exterior outer surfaces 18, 22 of the flanking first and second aluminum workpieces 12, 14 still generally face away from each other in opposite directions and constitute the top and bottom surfaces 26, 28 of the workpiece stack-up 10. Skilled artisans will know and appreciate that the remote laser welding method, including the following disclosure directed to a workpiece stack-up that includes two aluminum workpieces, can be readily adapted and applied to a workpiece stack-up that includes three overlapping aluminum workpieces without undue difficulty.

Referring back to FIGS. 1-3, the remote laser welding apparatus 16 includes a scanning optic laser head 54. The scanning optic laser head 54 focuses and directs a laser beam 56 at the top surface 26 of the workpiece stack-up 10 which, here, is provided by the outer surface 18 of the first aluminum workpiece 12. The scanning optic laser head 54 is preferably mounted to a robotic arm (not shown) that can quickly and accurately carry the laser head 54 to many different preselected weld sites on the workpiece stack-up 10 in rapid programmed succession. The laser beam 56 used in conjunction with the scanning optic laser head 54 is preferably a solid-state laser beam and, in particular, a fiber laser beam or a disk laser beam operating with a wavelength in the near-infrared range (commonly considered to be 700 nm to 1400 nm) of the electromagnetic spectrum. A preferred fiber laser beam is any laser beam in which the laser gain medium is either an optical fiber doped with rare-earth elements (e.g., erbium, ytterbium, neodymium, dysprosium, praseodymium, thulium, etc.) or a semiconductor associated with a fiber resonator. A preferred disk laser beam is any laser beam in which the gain medium is a thin disk of ytterbium-doped yttrium-aluminum Garnet crystal coated with a reflective surface and mounted to a heat sink.

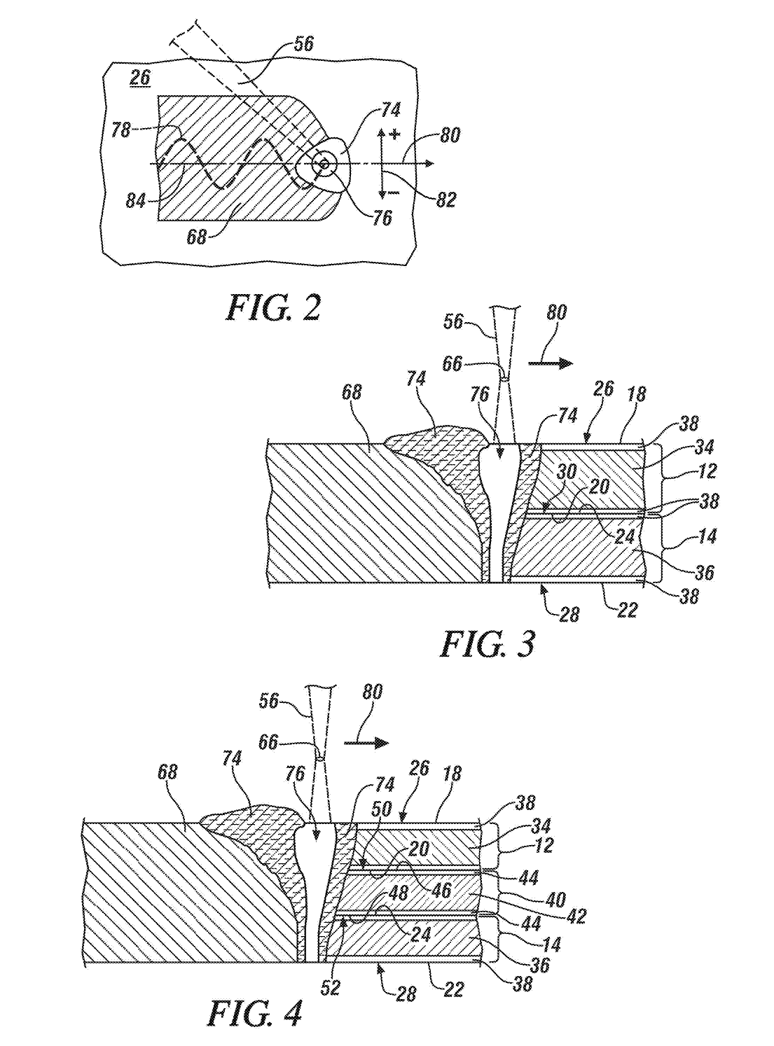

The scanning optic laser head 54 includes an arrangement of mirrors 58 that maneuver the laser beam 56 within a two-dimensional process envelope 60 that encompasses the weld site 32. The arrangement of mirrors 58 includes a pair of tiltable scanning mirrors 62. Each of the tiltable scanning mirrors 62 is mounted on a galvanometer. The two tiltable scanning mirrors 62 can move the laser beam 56 anywhere in the x-y plane of the top surface 26 encompassed by the operating envelope 60 through precise coordinated tilting movements executed by the galvanometers. In addition to the tiltable scanning mirrors 62, the laser head 54 also includes a z-axis focal lens 64, which can move a focal point 66 (FIG. 3) of the laser beam 56 in a z-direction that is oriented perpendicular to the x-y plane. All of these optical components 62, 64 can be rapidly indexed in a matter of milliseconds or less to focus and direct the laser beam 56 precisely as intended at the workpiece stack-up 10 to form a laser weld joint 68 (shown from the top in FIGS. 1-2 and in cross-section in FIG. 3) that autogenously fusion welds the first and second aluminum workpieces 12, 14 together. And, to keep dirt and debris from adversely affecting the optical system and ultimately the weld joint 68, a cover slide 70 may be situated below the scanning optic laser head 54. The cover slide 70 protects the tiltable mirrors 62 and the z-axis focal lens 64 from the environment yet allows the laser beam 56 to pass out of the laser head 54 without substantial disruption.

A characteristic that differentiates remote laser welding (also sometimes referred to as “welding on the fly”) from other more-conventional forms of laser welding is the focal length of the laser beam. Here, as shown in best in FIG. 1, the laser beam 56 has a focal length 72, which is measured as the distance between the focal point 66 and the last tiltable scanning mirror 62 that intercepts and reflects the laser beam 56 prior to the laser beam 56 impinging the top surface 26 of the workpiece stack-up 10 (also the outer surface 18 of the first aluminum workpiece 12). The focal length 72 of the laser beam 56 is preferably in the range of 0.4 meters to 1.5 meters with a diameter of the focal point 66 typically ranging anywhere from 350 μm to 700 μm. The scanning optic laser head 54 shown generally in FIG. 1 and described above, as well as others that may be constructed somewhat differently, are commercially available from a variety of sources. Some notable suppliers of scanning optic laser heads and lasers for use with the remote laser welding apparatus 16 include HIGHYAG (World headquarters in Kleinmachnow, Germany) and TRUMPF Inc. (North American headquarters in Farmington, Conn.).

The weld joint 68 is formed between the first and second aluminum workpieces 12, 14 by advancing the laser beam 56 along a predefined travel path relative to the top surface 26 of the workpiece stack-up 10 according to a programmed laser weld schedule. As shown best in FIGS. 2 and 3, the laser beam 56 is initially directed at, and impinges, the top surface 26 of the workpiece stack-up 10 within the weld site 32. The heat generated from absorption of the focused energy of the laser beam 56 initiates melting of the first and second aluminum workpieces 12, 14 to create a molten aluminum weld pool 74 that penetrates into the workpiece stack-up 10 from the top surface 26 towards the bottom surface 28 and intersects the faying interface 30. Additionally, in a preferred implementation, the laser beam 56 also vaporizes the first and second aluminum workpieces 12, 14 directly beneath where it impinges the top surface 26 of the stack-up 10. This vaporizing action produces a keyhole 76, which is a column of vaporized aluminum that usually contains plasma. The keyhole 76 is formed within the molten aluminum weld pool 74 and exerts an outwardly-directed vapor pressure sufficient to prevent the surrounding molten aluminum weld pool 74 from collapsing inward.

Like the molten aluminum weld pool 74, the keyhole 76 also penetrates into the workpiece stack-up 10 from the top surface 26 toward the bottom surface 28 and intersects the faying interface 30 of the two aluminum workpieces 12, 14. In fact, the keyhole 76 provides a conduit for the laser beam 56 to deliver energy down into the workpiece stack-up 10, thus facilitating relatively deep and narrow penetration of the molten aluminum weld pool 74 into the workpiece stack-up 10 and a relatively small surrounding heat-affected zone. The keyhole 76 may fully penetrate the workpiece stack-up 10, in which case it extends from the top surface 26 of the workpiece stack-up 10 (also outer surface 18) through the bottom surface 28 of the workpiece stack-up 10 (also outer surface 22), as shown here in FIG. 3. Or, alternatively, the keyhole 76 may partially penetrate the workpiece stack-up 10, in which case it extends into the stack-up 10 from the top surface 26 of the workpiece stack-up 10 and across the faying interface 30, but does not reach the bottom surface 28 of the workpiece stack-up 10. The power level, travel velocity, and/or focal point position of the laser beam 56 may be controlled during the laser welding process so that the keyhole 76 penetrates the workpiece stack-up 10 to the desired depth.

After creation of the molten aluminum weld pool 74 (and preferably the keyhole 76), the laser beam 56 is advanced from a start point to an end point relative to the top surface 26 of the workpiece stack-up 10 within the weld site 32. Such advancement of the laser beam 56 occurs along a programmed travel path by coordinating the movement of the tiltable scanning mirrors 62 in the scanning optic laser head 54. The molten aluminum weld pool 74 is consequently translated along a corresponding course since it tracks the movement of the laser beam 56. Accordingly, as the laser beam 56 is advanced along its travel path, the molten aluminum weld pool 74 follows and leaves behind molten aluminum workpiece material in the wake of the progressing weld pool 74. This molten aluminum workpiece material quickly cools and solidifies into the weld joint 68—the weld joint 68 being comprised of re-solidified coalesced aluminum derived from each of the aluminum workpieces 12, 14—that autogenously fusion welds the workpieces 12, 14 together. Once the laser beam 56 reaches the end point of its travel path, the transmission of the laser beam 56 is ceased so that the laser beam 56 no longer impinges the top surface 26 of the workpiece stack-up 10. At this time, the keyhole 76 collapses (if present) and the molten aluminum weld pool 74 solidifies to complete the formation of the weld joint 68. More than one weld joint 68 may be formed within the weld site 32 in a similar manner if desired, as will be explained in more detail below.

Turning now to FIG. 2, the laser beam 56 is advanced from a start point to an end point along a travel path 78 that promotes disruption of any protective anti-corrosion coatings 38 present within the weld site 32—and thus minimizes weld defects derivable from the protective coatings 38 in the weld joint 68—without necessarily requiring any other pre-welding preparations of the workpiece stack-up 10. In general, the travel path 78 imposes movement of the laser beam 56 and, consequently, the molten aluminum weld pool 74, in two directions within the x-y plane of the top surface 26 of the workpiece stack-up 10: (1) a forward direction 80 and (2) back and forth in a lateral direction 82 oriented transverse to the forward direction 80. The forward direction 80 is the directional component of the movement of the laser beam 56 occurring along a mean centerline 84 of the travel path 78 that extends from the start point to the end point and coincides with the overall direction in which weld joint 68 is growing lengthwise. The lateral direction 82 is the directional component of the movement of the laser beam 56 representing purposeful deviations to either side of the mean centerline 84. These purposeful deviations in the lateral direction 82 may be of any form or profile that are intentionally induced and, for that reason, do not encompass minor unspecified deviations of a laser beam tracking an otherwise unidirectional travel path. To be sure, in many embodiments, given the precision that is attainable with remote laser welding, the deviations in the lateral direction 82 extend away from the mean centerline 84 by 0.05 mm to 3.0 mm on each side of the mean centerline 84.

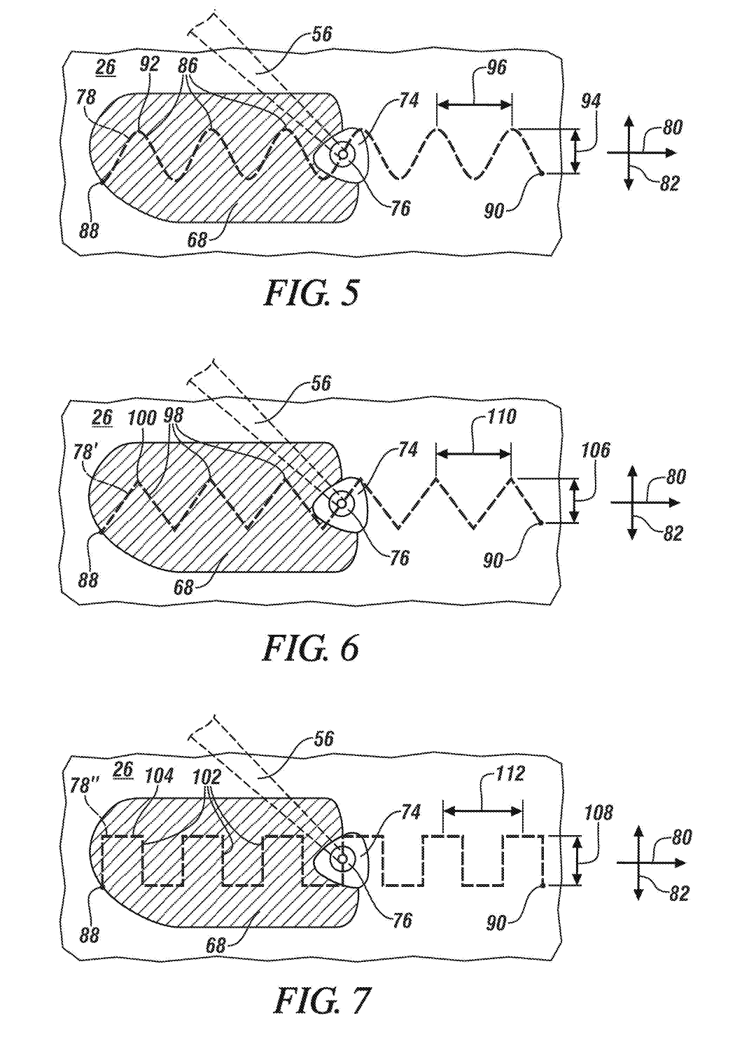

The exact shape and profile of the travel path 78 of the laser beam 56 can assume any of a wide variety of profiles while still experiencing movement in the forward direction 80 and movement back and forth in the lateral direction 82. One particularly effective type of bidirectional movement involves periodic oscillation of the laser beam 56 in the lateral direction 82 while moving the laser beam 56 in the forward direction 80. For example, in one embodiment, as shown in FIGS. 2 and 5, the travel path 78 embodies a sinusoidal pattern that includes repeating waves 86 as viewed from above as the travel path 78 is projected on the x-y plane of the top surface 26 of the workpiece stack-up 10 within the weld site 32. Thus, in order to be advanced from a start point 88 to an end point 90 along a travel path that includes the repeating waves 86, the laser beam 56 is oscillated back and forth in the lateral direction 82 between wave peaks 92 while moving in the forward direction 80. Such oscillation can render the repeating waves 86 continuous. A travel path in which the repeating waves 86 of a sinusoidal pattern are continuous—that is, the repeating waves 86 have constant amplitudes and wavelengths—is favored since it is easier to program and control. In a particularly preferred implementation of the sinusoidal pattern, the laser beam 56 is oscillated at a relatively constant frequency to induce repeating waves 86 characterized by peak-to-peak amplitudes 94 and wavelengths 96 ranging from 0.1 mm to 6.0 mm and from 0.1 mm to 6.0 mm, respectively.

A few alternative examples of a travel path in which the laser beam 56 can experience movement in the forward direction 80 and movement back and forth in the lateral direction 82 are depicted in FIGS. 6-8. For example, the travel path illustrated in FIG. 6, which is denoted by reference numeral 78′, embodies a zig-zag wave pattern that includes repeating triangles 98. Advancing the laser beam 56 along this type of travel path involves linearly oscillating the laser beam 56 back and forth in the lateral direction 82 between alternating vertices 100 while moving the laser beam 56 in the forward direction 80. As another example, the travel path illustrated in FIG. 7, which is denoted by reference numeral 78″, embodies a rectangular wave pattern that includes repeating plateaus 102. Advancing the laser beam 56 along this type of travel path involves linearly oscillating the laser beam 56 back and forth in the lateral direction 82 between alternating linear stages 104 while also moving the laser beam 56 in the forward direction 80. The triangles 98 and plateaus 102 shown in FIGS. 6-7 may be sized similarly to the repeating waves 86 shown in FIG. 5 and, as such, may be characterized by peak-to-peak amplitudes 106, 108 (between vertices 100 or linear stages 104) and wavelengths 110, 112 ranging from 0.1 mm to 6.0 mm and from 0.1 mm to 6.0 mm, respectively.

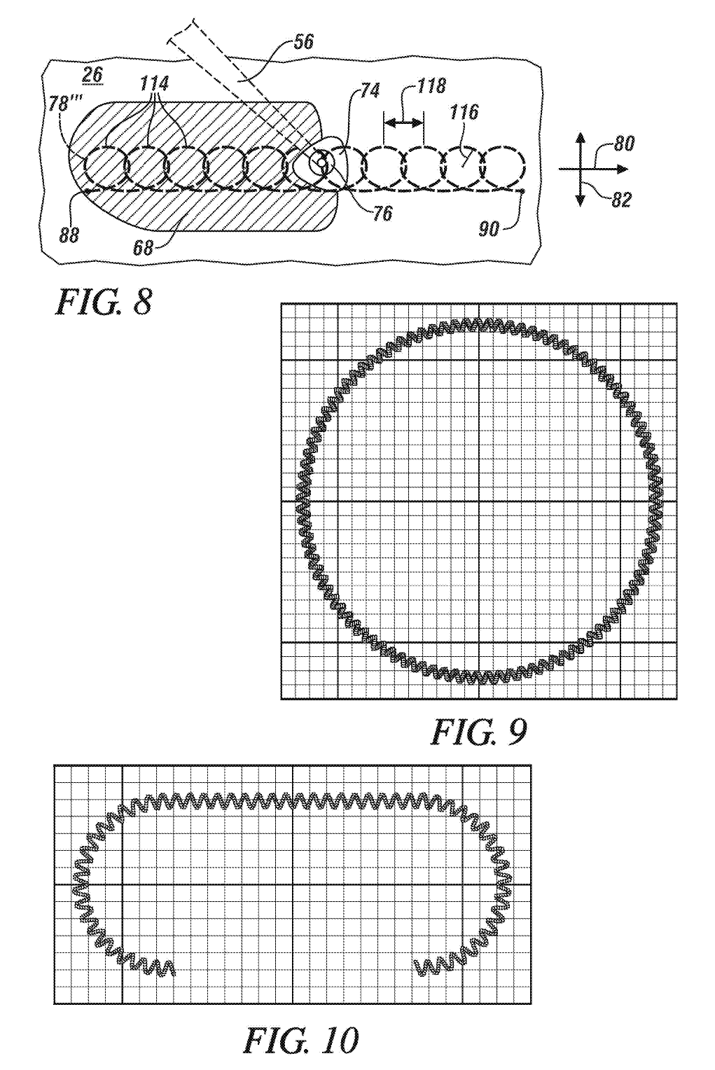

Another suitable travel path, which is denoted by reference numeral 78′, embodies a continuous loop pattern that includes a series of interconnected and overlapping loops 114, as shown in FIG. 8. This travel path of the laser beam 56 is somewhat different from the previously-discussed travel paths 78, 78′, 78″; indeed, the present travel path 78′″ having continuous loops 114 as projected in the x-y plane of the top surface 26 of the workpiece stack-up 10 does not emulate a periodic waveform like the travel paths 78, 78′, 78″ illustrated in FIGS. 5-7. Rather, the loops 114 of the present travel path 78′″ are continuously curved in trajectory and spaced close enough together that each loop 114 intersects its preceding loop 114 when completing the aft portion of its trajectory. Thus, in order to be advanced along this type of travel path, the laser beam 56 is gyrated to produce the continuous and intersecting loops 114, which involves repeated rotational movement in the lateral direction 82, while moving in the forward direction 80. The loops 114 tracked by the laser beam 56 may vary in size and spacing, although in many instances the loops 114 are characterized by radii 116 that range from 0.1 mm to 6.0 mm and midpoint distances 118 (measured between the centers of adjacent loops 114) that range from 0.1 mm to 6.0 mm.

The programmed laser welding schedule that controls the overall laser welding method can execute instructions that dictate the profile of the travel path 78 of the laser beam 56, which can be any of the specific travel paths 78, 78′, 78″, 78′″ shown here as well as variations not shown. It can also execute instructions detailing other parameters of the laser beam 56 including (1) the power level, (2) the travel velocity, and (3) the focal point location relative to the top surface 26 of the workpiece stack-up 10 in the z-direction. Each of these three laser welding parameters may be varied to ensure the laser beam 56 creates the molten aluminum weld pool 74 (and preferably produces the keyhole 76 to the desired penetration depth) and acceptably forms the weld joint 68 while being advanced along its predetermined travel path 78. In many instances, and regardless of the profile of the travel path 78, the power level of the laser beam 56 is typically between 0.2 kW and 50 kW, and more narrowly between 1.0 kW and 10.0 kW, the travel velocity of the laser beam 56 is typically between 1.0 meters per minute and 50 meters per minute, and the focal point location of the laser beam 56 is typically set at the bottom surface 28 of the workpiece stack-up 10.

Without being bound by theory, it is currently believed that the bidirectional movement of the laser beam 56, as exemplified by the travel paths 78, 78′, 78″, 78′″ discussed above, helps minimize the occurrence of weld defects derivable from the protective anti-corrosion coatings 38 in the weld joint 68, thereby helping ensure adequate and consistently-attainable strength in the joint 68. The back and forth movement of the laser beam 56 in the lateral direction 82, in particular, are believed to induce constant changes in the molten metal fluid velocity field within the molten aluminum weld pool 74, causing more disturbance (fracture and break down of a refractory oxide coating, boiling and zinc oxide formation of a zinc coating, etc.) of the protective anti-corrosion coating(s) 38. Moreover, due to the movement of the laser beam 56 in the lateral direction 82, such enhanced disturbance of the protective anti-corrosion coating(s) 38 occurs over a wider swath in an around the course of the molten aluminum weld pool 74 in comparison to strict unidirectional movement of the laser beam 56 in the forward direction 80 according to conventional practices of laser welding.

The weld joint 68 formed by the laser beam 56 may assume any desirable overall shape as projected onto the x-y plane of the top surface 26 of the workpiece stack-up 10. For example, the weld joint 68 may be a spiral or circular spot weld joint, a stitch weld joint, a staple weld joint, or any other shape. A plan view of a laser beam travel path possessing a sinusoidal pattern that would result in a circular weld joint, a stitch weld joint, and a staple weld joint is shown in FIG. 9, FIG. 10, and FIG. 11, respectively. More than one weld joint 68 may even be incorporated into the same weld site 32. Forming multiple weld joints 68 in close proximity to each other within the weld site 32 has been found to be particularly helpful when the base aluminum substrates 34, 36 of at least one of the aluminum workpieces 12, 14 are coated with a passively-formed refractory oxide coating as its protective anti-corrosion coating 38. This mechanically tough, electrically insulating, and self-healing coating is typically comprised of aluminum oxides, but may include other metal oxide compounds as well, including magnesium oxides when the aluminum workpiece is composed of a magnesium-containing aluminum alloy. The formation of multiple weld joints 68 is thought to collectively breach and disperse a relatively substantial portion of such an onerous coating material within a localized region such that each of the multiple weld joints 68 is stronger than if it had been formed alone.

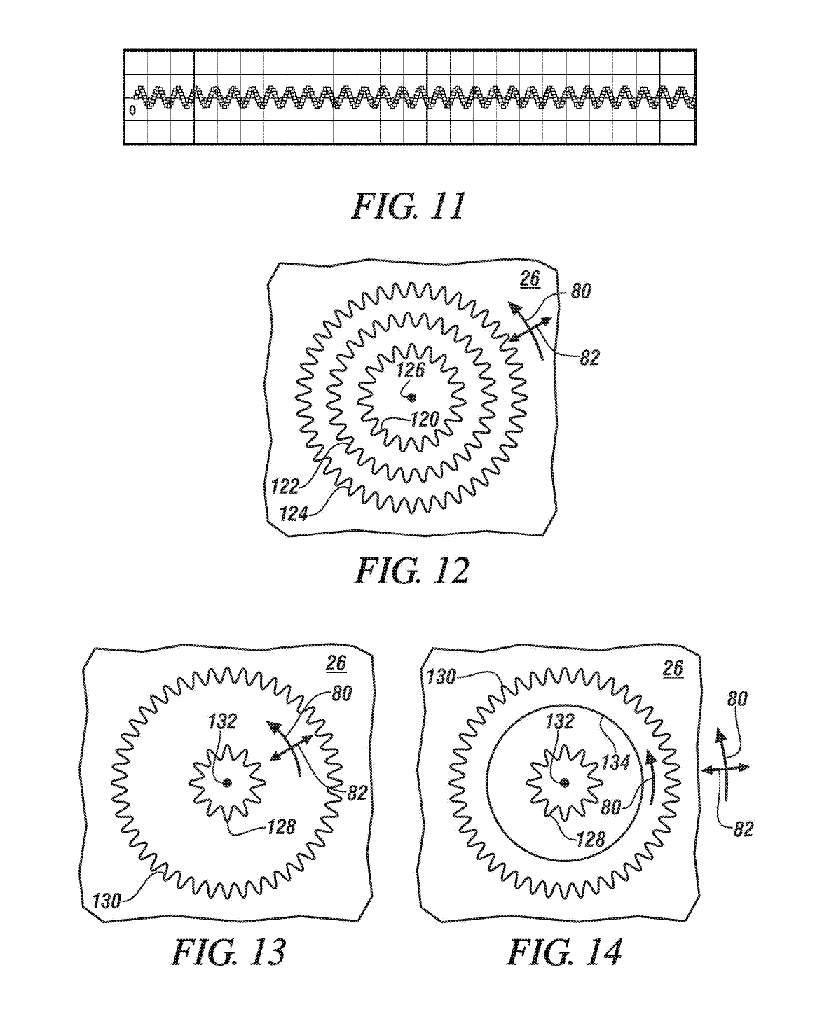

FIGS. 12-14 depict several exemplary laser beam travel paths that are employed to form multiple weld joints 68 at a weld site 32 in a workpiece stack-up 10 that includes at least the first and second overlapping aluminum workpieces 12, 14. In each instance, the laser beam 56 is programmed to be advanced relative to the top surface 26 of the workpiece stack-up 26 along two or more circle travel paths, although many other overall geometric shapes of the travel paths may be employed despite not being illustrated here. For example, in FIG. 12, the laser beam 56 is advanced along an inner circle path 120, an intermediate circle path 122 that surrounds the inner circle path 120, and an outer circle path 124 that surrounds both the inner circle path 120 and the intermediate circle path 122. Each of the circle paths 120, 122, 124 has coincident start points and end points (i.e., the start point of the circle path is essentially the same as the end point on the top surface 26 of the workpiece stack-up 10) and may be concentric about a central point 126. As for their size, the inner circle path 120, the intermediate circle path 122, and the outer circle path 124 may have diameters that range from 1.5 mm to 4.5 mm, 3.5 mm to 6.5 mm, and 5.5 mm to 8.5 mm, respectively.

While being advanced along at least one of the circle paths 120, 122, 124—and preferably all three of the circle paths 120, 122, 124 as shown here in FIG. 12—the laser beam 56 experiences movement in the forward direction 80 while also experiencing movement back and forth in the lateral direction 82. Such bidirectional movement of the laser beam 56 is achieved in FIG. 12 by employing a sinusoidal pattern, which has the characteristics described previously, whose forward direction 80 is curved to complete a full circle when moving from the start point to the end point of the circle paths 120, 122, 124. The advancement of the laser beam 56 along the multiple circle paths 120, 122, 124 may occur in any temporal order. To be sure, in one embodiment, the laser beam 56 may be advanced along the inner circle path 120 first, followed by the intermediate circle path 122 and then the outer circle path 124. Or, in another embodiment, the laser beam 56 may be advanced along the outer circle path 124 first followed by the intermediate circle path 122 and then the inner circle path 120. Still further, the laser beam 56 may be advanced along the intermediate circle path 122 first followed by either the inner circle path 120 or the outer circle path 124 and eventually the remaining circle path 120, 124 last.

The formation of multiple weld joints 68 in close proximity to one another may increase the chances that burn through will occur at the weld site 32. To lessen the potential for burn through to occur, the power level and/or the travel velocity of the laser beam 56 may be adjusted to reduce the heat input into the workpiece stack-up 10 after formation of the first of three weld joints 68. For example, and referring still to FIG. 12, the circle path 120, 122, 124 along which the laser beam 56 is advanced first in time (which may be any of the circle paths 120, 122, 124 to thus form the first of three weld joints 68) may have a power level that is greater than a power level of the circle paths 120, 122, 124 along which the laser beam 56 is advanced second in time and third in time. In fact, in a specific implementation of FIG. 12, the travel velocity of the laser beam 56 is set to between 2.0 meters per minute to 4.0 meters per minute relative to the top surface 26 when being advanced along each of the inner, intermediate, and outer circle paths 120, 122, 124, but its power level is higher during advancement along the circle path 120, 122, 124 tracked first in time than during advancement along the circle path 120, 122, 124 tracked second in time and third in time. In particular, with the focal point 66 being located at the bottom surface 28 of the workpiece stack-up 10, the laser beam 56 may have a power level of between 3.0 kW and 4.0 kW during advancement along the first (in time) circle path and a power level of between 2.3 kW and 3.3 kW during advancement along the second and third (in time) circle paths.

FIGS. 13 and 14 depict additional examples of laser beam travel paths that would form multiple weld joints 68 at a weld site 32. In FIG. 13, the laser beam 56 tracks an inner circle path 128 and an outer circle path 130 that surrounds the inner circle path 128. And, like before with FIG. 12, each of the circle paths 128, 130 has coincident start points and end points and may be concentric about a central point 132. As for their size, the inner circle path 128 and the outer circle path 130 may have diameters that range from 0.5 mm to 3.5 mm and 5.5 mm to 8.5 mm, respectively. While being advanced along at least one of the circle paths 128, 130—and preferably both of the circle paths 128, 130 as shown here in FIG. 13—the laser beam 56 experiences movement in the forward direction 80 while also experiencing movement back and forth in the lateral direction 82. Such bidirectional movement of the laser beam 56 is achieved in FIG. 13 by employing a sinusoidal pattern, which has the characteristics described previously, whose forward direction 80 is curved to complete a full circle when moving from the start point to the end point of the circle paths 128, 130.

The two circle paths 128, 130 may be tracked by the laser beam 56 in any temporal order; that is, the laser beam 56 may be advanced first in time along the inner circle path 128 and second in time along the outer circle path 130, or it may be advanced first in time along the outer circle path 130 and second in time along the inner circle path 128. The power level and/or travel velocity of the laser beam 56 may also be adjusted to reduce the heat input after formation of the first of the two weld joints 68. In fact, in a specific implementation of FIG. 13, the travel velocity of the laser beam 56 is set to between 2.0 meters per minute to 4.0 meters per minute relative to the top surface 26 when being advanced along each of the inner and outer circle paths 128, 130, but its power level is higher during advancement along the circle path 128, 130 tracked first in time than during advancement along the circle path 128, 130 tracked second in time. In particular, with the focal point 66 being located at the bottom surface 28 of the workpiece stack-up 10, the laser beam 56 may have a power level of between 2.9 kW and 3.9 kW during advancement along the first (in time) circle path 128, 130 and a power level of between 2.15 kW and 3.15 kW during advancement along the second (in time) circle path 128, 130.

The laser beam travel paths depicted in FIG. 14 are similar to those depicted in FIG. 13 except that an additional intermediate circle path 134 is added between the inner circle path 128 and the outer circle path 130. The inner and outer circle paths 128, 130 are similar to those of FIG. 13 in that the laser beam 56 experiences movement in the forward direction 80 while also experiencing movement back and forth in the lateral direction 82 while being advanced along circle paths 128, 130 relative to the top surface 26 of the workpiece stack-up 10. Such bidirectional movement is achieved by employing a sinusoidal pattern, which has the characteristics described previously, whose forward direction 80 is curved to complete a full circle when moving from the start point to the end point of the circle paths 128, 130. With respect to the intermediate circle path 134, however, the laser beam 56 does not experience such bidirectional movement, but rather experiences only unidirectional movement in the forward direction 80. As for their size, the inner circle path 128, the intermediate circle path 134, and the outer circle path 130 may have diameters that range from 0.5 mm to 3.5 mm, 3.5 mm to 6.5 mm, and 5.5 mm to 8.5 mm, respectively.

Additionally, as before, the power level and/or travel velocity of the laser beam 56 may be adjusted to reduce the heat input after formation of the first of three weld joints 68 so as to help reduce the potential for burn through at the weld site 32. Here, for example, when being advanced along the circle path 128, 134, 130 tracked first in time (which may be any of the circle paths 128, 134, 130) with the focal point 66 being located at the bottom surface 28 of the workpiece stack-up 10, the travel velocity of the laser beam 56 is set to between 3.0 meters per minute and 5.0 meters per minute and the power level of the laser beam 56 is set to between 2.8 kW and 3.8 kW. Next, when being advanced along the circle path 128, 134, 130 tracked second in time (the focal point position remaining the same), the travel velocity of the laser beam 56 is set to between 4.0 meters per minute and 6.0 meters per minute and the power level of the laser beam 56 is set to between 2.6 kW and 3.6 kW. Finally, when being advanced along the circle path 128, 134, 130 tracked third in time (the focal point position remaining the same), the travel velocity of the laser beam 56 is set to between 4.0 meters per minute and 6.0 meters per minute and the power level of the laser beam 56 is set to between 2.4 kW and 3.4 kW.

FIGS. 12-14 are thus directed to embodiments in which the laser beam 56 is advanced along multiple travel paths to ultimately form multiple weld joints 68. The multiple travel paths shown and described are circle paths, meaning that the forward direction 80 of the laser beam 56 is curved to complete a circle in which the start point and the end point of the path are preferably, but not necessarily, coincident. The term “circle path” as used above with regards to FIGS. 12-14 is not limited to strict circular paths that have a constant radius, but rather refers to, and is meant to cover, any curved path that resembles a circle such as elliptical paths, hexagonal paths, and octagonal paths, to name a few examples. The laser beam 56 may experience bidirectional movement, such as through sinusoidal oscillation, while being advanced along any or all of the multiple circle paths. Furthermore, depending on the spacing of the multiple laser beam travel paths, the re-solidifed workpiece aluminum that constitutes the resultant weld joints 68 may overlap to some extent or be separated by portions of the aluminum workpieces that have not been melted by the laser beam 56. In other words, when the laser beam 56 is being advanced along one of the laser beam travel paths, the molten aluminum weld pool 74 being translated along a corresponding course may, in some instances, make contact with the re-solidified workpiece aluminum of a weld joint 68 associated with a travel path that has already been tracked by the laser beam 56. Such interaction of the weld joints 68 is not seen as being categorically unacceptable.

The above description of preferred exemplary embodiments and specific examples are merely descriptive in nature; they are not intended to limit the scope of the claims that follow. Each of the terms used in the appended claims should be given its ordinary and customary meaning unless specifically and unambiguously stated otherwise in the specification.

1. A method of laser welding overlapping aluminum workpieces, the method comprising:
(a) providing a workpiece stack-up that includes overlapping aluminum workpieces, the workpiece stack-up comprising at least a first aluminum workpiece and a second aluminum workpiece, the first aluminum workpiece providing a top surface of the workpiece stack-up and the second aluminum workpiece providing a bottom surface of the workpiece stack-up, wherein a faying interface is established between each pair of adjacent overlapping aluminum workpieces within the workpiece stack-up, and wherein at least one of the aluminum workpieces in the workpiece stack-up includes a protective anti-corrosion coating;
(b) directing a laser beam at the top surface of the workpiece stack-up to create a molten aluminum weld pool that penetrates into the workpiece stack-up from the top surface towards the bottom surface and intersects each faying interface established within the workpiece stack-up; and
(c) advancing the laser beam relative to the top surface of the workpiece stack-up and along a travel path so as to translate the molten aluminum weld pool along a corresponding course and to form a weld joint comprised of re-solidified aluminum workpiece material as the molten aluminum weld pool is conveyed relative to the top surface of the workpiece stack-up, advancement of the laser beam from a start point to an end point of the travel path comprising moving the laser beam in a forward direction away from the start point and towards the end point and further moving the laser beam back and forth in a lateral direction oriented transverse to the forward direction.

2. The method set forth in claim 1, wherein the first aluminum workpiece has an outer surface and a first faying surface, and the second aluminum workpiece has an outer surface and a second faying surface, the outer surface of the first aluminum workpiece providing the top surface of the workpiece stack-up and the outer surface of the second aluminum workpiece providing the bottom surface of the workpiece stack-up, and wherein the first and second faying surfaces of the first and second aluminum workpieces overlap and confront each other to establish a faying interface.

3. The method set forth in claim 1, wherein the first aluminum workpiece has an outer surface and a first faying surface, and the second aluminum workpiece has an outer surface and a second faying surface, the outer surface of the first aluminum workpiece providing the top surface of the workpiece stack-up and the outer surface of the second aluminum workpiece providing the bottom surface of the workpiece stack-up, and wherein the workpiece stack-up comprises a third aluminum workpiece situated between the first and second aluminum workpieces, the third aluminum workpiece having opposed faying surfaces, one of which overlaps and confronts the first faying surface of the first aluminum workpiece to establish a first faying interface and the other of which overlaps and confronts the second faying surface of the second aluminum workpiece to establish a second faying interface.

4. The method set forth in claim 1, wherein each of the aluminum workpieces in the workpiece stack-up is covered with a protective anti-corrosion coating.

5. The method set forth in claim 1, wherein the protective anti-corrosion coating is a passively-formed refractory oxide coating.

6. The method set forth in claim 1, wherein advancing the laser beam is performed by a scanning optic laser head having tiltable scanning mirrors whose movements are coordinated to move the laser beam in both the forward direction and the lateral direction relative to the top surface of the workpiece stack-up.

7. The method set forth in claim 6, wherein the laser beam is a solid-state fiber laser beam or a solid state disk laser beam.

8. The method set forth in claim 1, wherein advancing the laser beam relative to the top surface of the workpiece stack-up from the start point to the end point of the travel path comprises periodically oscillating the laser beam to produce a waveform pattern.

9. The method set forth in claim 8, wherein the laser beam is oscillated in a sinusoidal pattern that includes repeating waves characterized by peak-to-peak amplitudes and wavelengths ranging from 0.1 mm to 6.0 mm and from 0.1 mm to 6.0 mm, respectively.

10. The method set forth in claim 1, wherein the laser beam is linearly oscillated in a rectangular wave pattern that includes repeating plateaus characterized by peak-to-peak amplitudes and wavelengths ranging from 0.1 mm to 6.0 mm and from 0.1 mm to 6.0 mm, respectively.

11. The method set forth in claim 1, wherein the laser beam is linearly oscillated in a zig-zag wave pattern that includes repeating triangles characterized by peak-to-peak amplitudes and wavelengths ranging from 0.1 mm to 6.0 mm and from 0.1 mm to 6.0 mm, respectively.

12. The method set forth in claim 1, wherein advancing the laser beam relative to the top surface of the workpiece stack-up from the start point to the end point of the travel path comprises gyrating the laser beam to produce a continuous loop pattern that includes interconnected and overlapping loops characterized by radii that range from 0.1 mm to 6.0 mm and midpoint distances that range from 0.1 mm to 6.0 mm.

13. The method set forth in claim 1, wherein the travel path along which the laser beam is advanced is a circle path in which the forward direction is curved to complete a circle.

14. The method set forth in claim 13, further comprising:
(d) repeating steps (b) and (c) to form another weld joint comprised of re-solidified aluminum workpiece material, wherein the travel path along which the laser beam is advanced in repeated steps (b) and (c) to form the another weld joint is a circle path that surrounds, or is surrounded by, the circle path along which the laser beam is advanced in original steps (b) and (c) to form the weld joint.

15. A method of laser welding overlapping aluminum workpieces, the method comprising:
(a) providing a workpiece stack-up that includes overlapping aluminum workpieces, the workpiece stack-up comprising at least a first aluminum workpiece and a second aluminum workpiece, the first aluminum workpiece providing a top surface of the workpiece stack-up and the second aluminum workpiece providing a bottom surface of the workpiece stack-up, wherein a faying interface is established between each pair of adjacent overlapping aluminum workpieces within the workpiece stack-up, and wherein at least one of the aluminum workpieces in the workpiece stack-up includes a passively-formed refractory oxide coating;
(b) operating a scanning optic laser head to direct a solid-state laser beam at the top surface of the workpiece stack-up to create a molten aluminum weld pool that penetrates into the workpiece stack-up from the top surface towards the bottom surface and intersects each faying interface established within the workpiece stack-up, the solid-state laser beam having a focal length between 0.4 meters and 1.5 meters; and
(c) coordinating the movement of tiltable scanning mirrors within the scanning optic laser head to advance the laser beam relative to the top surface of the workpiece stack-up and along a travel path from a start point of the travel path to an end point of the travel path, such advancement of the laser beam translating the molten aluminum weld pool along a corresponding course such that a weld joint comprised of re-solidified aluminum workpiece material is formed as the molten aluminum weld pool is conveyed relative to the top surface of the workpiece stack-up, advancement of the laser beam from the start point to the end point of the travel path comprising moving the laser beam in a forward direction away from the start point and towards the end point and further moving the laser beam back and forth in a lateral direction oriented transverse to the forward direction.

16. The method set forth in claim 15, wherein the first aluminum workpiece has an outer surface and a first faying surface, and the second aluminum workpiece has an outer surface and a second faying surface, the outer surface of the first aluminum workpiece providing the top surface of the workpiece stack-up and the outer surface of the second aluminum workpiece providing the bottom surface of the workpiece stack-up, and wherein the first and second faying surfaces of the first and second aluminum workpieces overlap and confront each other to establish a faying interface.

17. The method set forth in claim 15, wherein the first aluminum workpiece has an outer surface and a first faying surface, and the second aluminum workpiece has an outer surface and a second faying surface, the outer surface of the first aluminum workpiece providing the top surface of the workpiece stack-up and the outer surface of the second aluminum workpiece providing the bottom surface of the workpiece stack-up, and wherein the workpiece stack-up comprises a third aluminum workpiece situated between the first and second aluminum workpieces, the third aluminum workpiece having opposed faying surfaces, one of which overlaps and confronts the first faying surface of the first aluminum workpiece to establish a first faying interface and the other of which overlaps and confronts the second faying surface of the second aluminum workpiece to establish a second faying interface.

18. The method set forth in claim 15, wherein steps (b) and (c) are performed two or more times in order to advance the laser beam relative to the top surface of the workpiece stack-up and along multiple travel paths of circular shape within a weld site to form multiple weld joints of re-solidified aluminum workpiece material, the multiple travel paths of circular shape comprising an inner circle weld path and an outer circle weld path that surrounds the inner circle weld path, the inner circle path having a diameter that ranges from 0.5 mm to 4.5 mm, and the outer circle path having a diameter that ranges from 5.5 mm to 8.5 mm.

19. The method set forth in claim 18, wherein a power level of the laser beam, a travel velocity of the laser beam, or both, is adjusted after the laser beam is advanced along whichever of the multiple travel paths is tracked by the laser beam first in time to reduce the heat input into the workpiece stack-up during advancement of the laser beam along the remaining of the multiple travel paths.

20. The method set forth in claim 18, wherein the solid-state laser beam is a fiber laser beam or a disk laser beam having a power level ranging from 0.2 kW to 50 kW, and wherein the solid-state laser beam is advanced along the travel path at a travel velocity ranging from 1.0 m/min to 50 m/min.
